(19) United States
(12) Patent Application Publication
(10) Pub. No.: US 2026/0237187 A1
(43) Pub. Date: Aug. 13, 2026

(54) METHOD AND SYSTEM FOR PET PHOTO CLASSIFICATION BASED ON IMAGE TAGGING

(71) Applicant: SK INC, Seoul (KR)

(72) Inventor: Jung Ho BAE, Yongin-si (KR)

(73) Assignee: SK INC, Seoul (KR)

(21) Appl. No.: 19/156,123

(22) PCT Filed: Mar. 8, 2024
(86) PCT No.: PCT/KR2024/002992

§ 371 Date: Aug. 13, 2025

(30) Foreign Application Priority Data
Mar. 23, 2023 (KR) 10-2023-0037961

(51) Int. Cl. G06V 10/764; G06Q 10/02; G06V 10/82

(52) U.S. Cl. CPC G06V 10/764; G06Q 10/02; G06V 10/82; G06V 2201/10

(57) ABSTRACT

Provided are a method and system for classifying pet photos on the basis of image tagging. A method for pet photo classification based on image tagging according to an embodiment of the present invention comprises the steps in which: a system registers information about a pet and information about a pet guardian received from a user terminal; the system, in conjunction with the user terminal, makes a reservation for the use of a pet care facility on the basis of the information about the pet and the information about the pet guardian; and the system determines whether the pet has visited the pet care facility on the basis of a photo of the pet taken at the pet care facility and reservation information registered while making the reservation. Accordingly, a service for determining whether a pet has visited (attended) a pet care facility on the basis of photos taken at the pet care facility, and sorting each of pets included in a group photo taken at the pet care facility and delivering same to the respective guardians of the pets can be provided to provide convenience to the pet guardians.

### TECHNICAL FIELD

The disclosure relates to a method and a system for classifying photos, and more particularly, to a method and a system for classifying pet photos based on image tagging.

### BACKGROUND ART

As the structure of society has changed with the development of industry, households with pets have been increasing due to aging, nuclearization, and rapid increase of single person-households.

As households treating pets as family members increases, users using pet care facilities (for example, pet kindergartens, pet hotels, pet grooming salons, etc.) for caring for pets are also rapidly increasing in recent years.

In such a pet care facility, as several pets are taken care of together, it may be difficult to classify who is whose pet if they are the same species.

In addition, there is no platform to provide users (pet guardians) with efficient information management and information sharing for pets using pet care facilities, and accordingly, there is a need for a solution to this problem.

### DISCLOSURE

### Technical Problem

The disclosure has been developed to solve the above-described problems, and an object of the disclosure is to provide a method and a system for classifying pet photos, which provide a service for determining whether a pet has visited (attended) a pet care facility based on an on-site photo of a pet vising the pet care facility, classifying pets included in a group photo taken in the pet care facility, and delivering photos to pet guardians.

### Technical Solution

According to an embodiment of the disclosure to achieve the above-described object, a method for classifying pet photos based on image tagging may include: a step of registering, by a system, information on a pet and information on a pet guardian which are received from a user terminal; a step of making a reservation, by the system in conjunction with the user terminal, for the use of a pet care facility, based on the information on the pet and the information on the pet guardian; and a step of determining, by the system, whether the pet has visited the pet care facility, based on a photo of the pet taken on the site of the pet care facility and reservation information registered while making the reservation.

The step of determining whether the pet has visited the pet care facility may include, when the pet photo taken on the site of the pet care facility is uploaded, determining whether the pet has visited the pet care facility, based on the reservation information registered while making the reservation and the uploaded pet photo.

In addition, the step of making the reservation may include making the reservation only when the pet guardian logged into a specific user terminal registers (purchases) a voucher of the pet care facility, and the step of determining whether the pet has visited the pet care facility may include, when the visit of the pet to the pet care facility is recognized based on the pet photo taken on the site of the pet care facility, automatically deducting the number of times that the pet guardian uses the voucher registered (purchased) at the user terminal.

When the visit of the pet to the pet care facility is recognized through the pet photo taken on the site of the pet care facility, the system may cause the name of the pet selected from a visit list or extracted from the reservation information to be stored as tagged onto the photo.

In addition, the system may extract an image of a specific pet by performing object detection for detecting the specific pet from a photo or a captured image including a plurality of pets by using a Few Shot Learning algorithm and Siamese Neural Networks.

When the Few Shot Learning algorithm and the Siamese Neural Networks are used, the system may apply pet photos included in the information of the pets registered or pet photos taken on the site of the pet care facility as a Support Set, and may apply the photo or captured image including the plurality of pets as a Query Set.

According to an embodiment of the disclosure, the method for classifying pet photos based on image tagging may further include, when the photo or captured image including the plurality of pets in the pet care facility is obtained, individually extracting, by the system, respective images of pets and mapping the images onto a most similar group within the Support Set, and classifying the images of the pets by pets according to the result of mapping.

The classified pet images may be filtered based on a pet care facility using time of each pet, and may be stored.

According to an embodiment of the disclosure, the method for classifying pet photos based on image tagging may further include, when a specific pet guardian requests an image of a pet obtained in the pet care facility through a user terminal, delivering, by the system, the image that is filtered and stored to the user terminal.

According to another embodiment of the disclosure, a system for classifying pet photos based on image tagging may include: a processor configured to register information on a pet and information on a pet guardian which are received from a user terminal, to make a reservation for the use of a pet care facility, based on the information on the pet and the information on the pet guardian, in conjunction with the user terminal, and to determine whether the pet has visited the pet care facility, based on a photo of the pet taken on the site of the pet care facility and reservation information registered while making the reservation; and a storage unit configured to store the information on the pet and the information on the pet guardian which are registered, and the reservation information registered while making the reservation.

### Advantageous Effects

As described above, according to embodiments of the disclosure, a service for determining whether a pet has visited (attended) a pet care facility based on an on-site photo of the pet visiting the pet care facility, classifying pets included in a group photo taken in the pet care facility, and delivering pet images to respective pet guardians may be provided, so that convenience may be provided to the pet guardians.

### DESCRIPTION OF DRAWINGS

FIG. 1 is a view provided to explain a configuration of a pet photo classification system according to an embodiment of the disclosure.

FIG. 2 is a flowchart provided to explain a pet photo classification method according to an embodiment of the disclosure.

FIG. 3 is a flowchart provided to explain a process of determining whether a pet have visited a pet care facility in detail according to an embodiment of the disclosure.

FIGS. 4 and 5 are views provided to explain a process of extracting pets from a pet photo or a pet image according to an embodiment of the disclosure.

FIG. 6 is a view provided to explain a process of delivering a tagged image to a pet guardian according to an embodiment of the disclosure.

### BEST MODE

Hereinafter, the disclosure will be described in more detail with reference to the drawings.

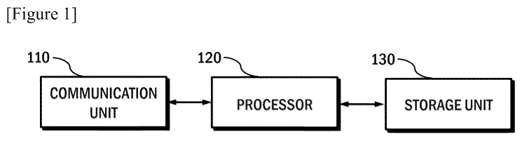

FIG. 1 is a view provided to explain a configuration of a pet photo classification system (hereinafter, referred to as a ‘system) according to an embodiment of the disclosure.

The system according to an embodiment may provide a service for determining whether a pet has visited (attended) a pet care facility based on an on-site photo of the pet visiting the pet care facility, classifying pets included in a group photo taken within the pet care facility, and delivering pet images to respective pet guardians.

To achieve this, the system may include a communication unit 110, a processor 120, and a storage unit 130.

The communication unit 110 may collect or provide information needed for the system to interwork with a user terminal (for example, a smartphone, a tablet PC, a laptop, or the like) that a pet guardian uses and for the processor 120 to operate.

The storage unit 130 is a storage medium that stores data and programs needed for the processor 120 to operate.

The processor 120 is provided to process overall operations of the system.

For example, the processor 120 may determine whether a pet has visited (attended) a pet care facility based on an on-site photo of the pet visiting the pet care facility, and may automatically deduct the number of times that the pet care facility is used from a voucher.

Specifically, the processor 120 may register information of a pet and information of a pet guardian which are provided from a user terminal, and may cause the information to be stored in the storage unit 130.

The processor 120 may make a reservation for the use of the pet care facility based on the information of the pet and the information of the pet guardian, and may determine whether the pet has visited the pet care facility, based on a pet photo taken on the site of the pet care facility and reservation information registered while making the reservation.

In this case, when the visit of the corresponding pet to the pet care facility is recognized through the photo of the pet taken on the site of the pet care facility, the processor 120 may cause the pet's name selected from a visit list or extracted from the reservation information to be stored in the storage unit 130 as tagged onto the photo.

In addition, the processor 120 may classify pets included in a group photo taken in the pet care facility, and may deliver images of the pets to user terminals that respective pet guardians use.

Specifically, when a photo or a captured image including a plurality of pets in the pet care facility is obtained, the processor 120 may individually extract images of pets and may map the pet images onto a most similar group within a support set, and may classify the pet images by pets according to the result of mapping and may store the pet images.

In addition, when a specific pet guardian requests an image of the guardian's pet obtained in the pet care facility through a user terminal, the processor 120 may deliver a stored pet image to the user terminal.

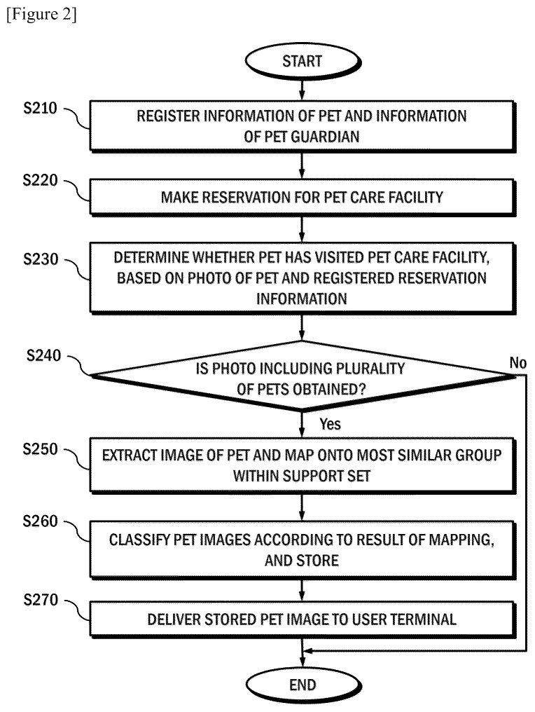

FIG. 2 is a flowchart provided to explain a pet photo classification method according to an embodiment of the disclosure.

The pet photo classification method according to an embodiment may be executed by the system described above with reference to FIG. 1.

Referring to FIG. 2, the pet photo classification method may register information of a pet and information of a pet guardian which are provided from a user terminal through the system (S210).

The pet photo classification method may make a reservation for the use of a pet care facility based on the information of the pet and the information of the pet guardian (S220), and may determine whether the pet has visited the pet care facility, based on a pet photo taken on the site of the pet care facility and reservation information registered while making the reservation (S230).

When the visit of the corresponding pet to the pet care facility is recognized through the photo of the pet taken on the site of the pet care facility, the system may cause the pet's name selected from a visit list or extracted from the reservation information to be stored as tagged onto the photo.

Meanwhile, when a photo or a captured image including a plurality of pets in the pet care facility is obtained (S240—Yes), the pet photo classification method may individually extract images of pets and may map the pet images onto a most similar group within a support set (S250), and may classify the pet images by pets according to the result of mapping and may store the pet images (S260).

In addition, when a specific pet guardian requests an image of the guardian's pet obtained in the pet care facility through a user terminal, the pet photo classification method may deliver a stored pet image to the user terminal (S270).

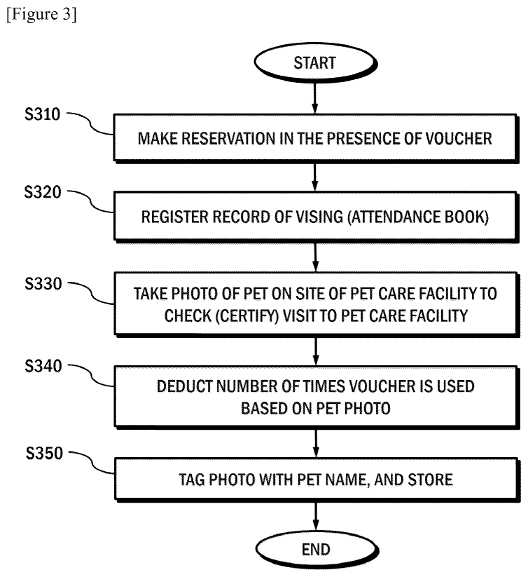

FIG. 3 is a flowchart provided to explain a process of determining whether a pet has visited a pet care facility according to an embodiment of the disclosure.

Prior to accessing the system and making a reservation to use the pet care facility, each pet guardian has to obtain (purchase) a voucher (for example, a mobile ticket) to use the pet care facility. That is, a pet guardian logged into a specific user terminal may make a reservation only when the pet guardian has registered (purchased) a voucher for the pet care facility.

To achieve this, the system may sell the voucher (for example, a mobile ticket) for the use of the pet care facility to pet guardians, and each pet guardian may access a server through the user terminal and may purchase the voucher for the specific pet care facility.

After purchasing the voucher to use the specific pet care facility using the user terminal, a specific pet guardian may access the system and make a reservation to use the specific pet care facility (S310), and then, may visit the pet care facility on a reserved date, time, and may register a record of visiting (attendance book) (S320).

Here, the registration of the record of visiting may be performed at the reserved pet care facility by executing an application provided by the system by using the user terminal, and a pet photo may be taken on the site of the pet care facility (S330), and may be uploaded, and a procedure of checking (certifying) the visit to the pet care facility may be performed.

When the pet photo taken on the site of the pet care facility is uploaded, the system may determine whether the corresponding pet has visited the pet care facility, based on reservation information registered while making the reservation and the uploaded pet photo, and, when the visit to the pet care facility is recognized based on the pet photo taken on the site of the pet care facility, the system may automatically deduct the number of times that the pet guardian uses the voucher registered (purchased) at the user terminal (S340).

In addition, when the visit to the pet care facility is recognized based on the pet photo taken on the site of the pet care facility, the system may cause the pet's name selected from a visit list or extracted from reservation information to be stored as tagged onto the photo (S350).

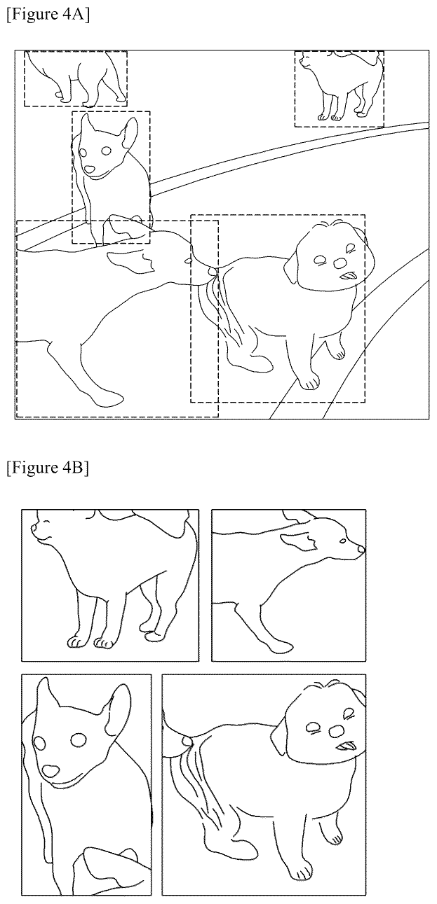

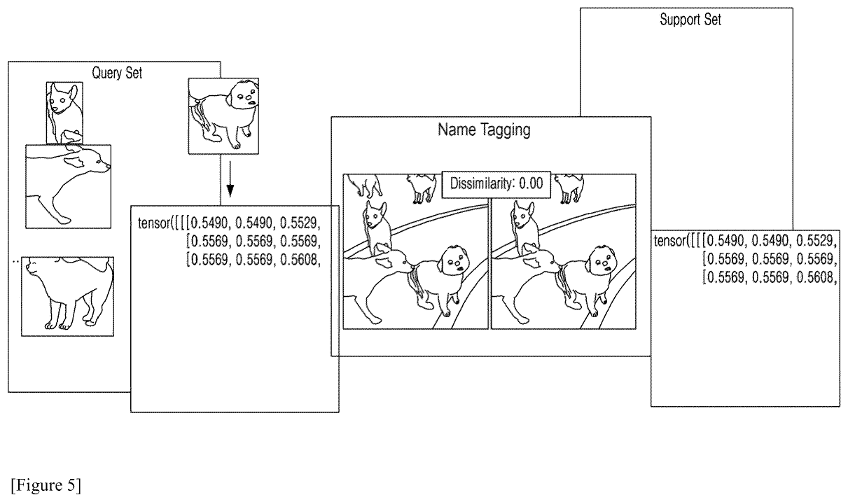

FIG. 4A is a view illustrating an example of object detection of each pet in a photo including a plurality of pets, FIG. 4B is a view illustrating an example of a photo of each pet detected and extracted, and FIG. 5 is a view provided to explain a process of tagging a name onto a most similar pet by extracting features from pet photos included in pet information already registered as a Support Set, or pet photos taken on the site of the pet care facility, and comparing the extracted features with features of pet photos applied as a Query Set.

When a photo or a captured image including a plurality of pets in the pet care facility is obtained, the system may extract images of pets individually and may apply the images as a Query Set, and may map the pet images onto the most similar group within the Support Set, and may classify the pet images by pets according to the result of mapping.

In this case, the system may extract an image of a specific pet by detecting (object detection) the specific pet from the photo or captured image including the plurality of pets by using a Few Shot Learning algorithm and Siamese Neural Networks, as shown in FIG. 4A.

When the Few Shot Learning algorithm and the Siamese Neural Networks are used, the system may apply pet photos included in registered pet information, or pet photos taken on the site of the pet care facility as a Support Set, and may apply a photo or a captured image including a plurality of pets as a Query Set.

That is, the system may apply pet photos registered at the Few Shot Learning algorithm and the Siamese Neural Networks as a Support Set to extract a corresponding pet the photo of which is registered from the photo or captured image including the plurality of pets, which corresponds to a Query Set.

Here, the classified pet images may be filtered based on information on a pet care facility using time of each pet, and may be stored.

That is, the system may filter the result of classifying pet images by pets according to the result of mapping, based on information on a pet care facility using time of each pet, and, when the result indicates that an image of pet A is classified at the time at which pet A does not use the pet care facility, the system may filter out (remove) the result.

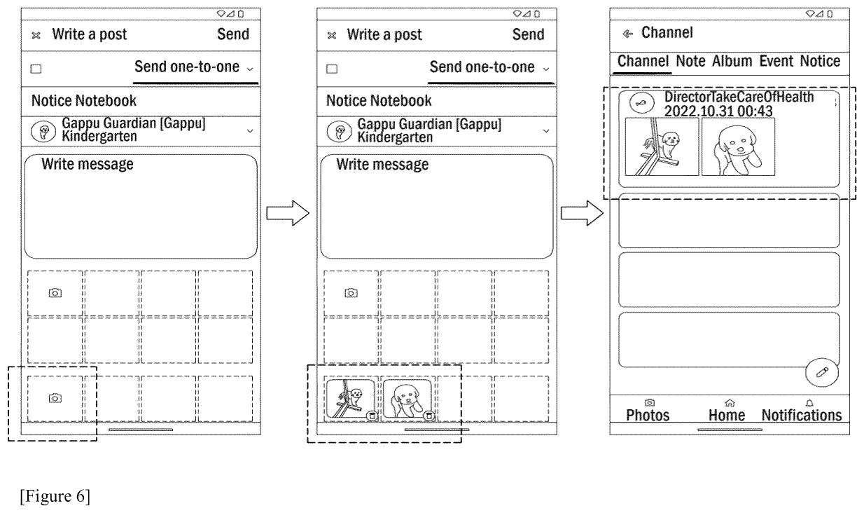

FIG. 6 is a view provided to explain a process of delivering a tagged image to a pet guardian according to an embodiment of the disclosure.

The system may obtain a photo or a captured image including a specific pet that is taken care of with other pets while staying at the pet care facility. Here, since various conditions are set to obtain a photo or a captured image according to an installation environment of CC TVs and cameras installed at the pet care facility, the system may monitor activities of pets and may obtain pet photos.

As described above with reference to FIGS. 4 and 5, when the photo or captured image of pets is obtained, the system may extract images of pets individually, and may map the pet images onto a most similar group within a Support Set, and may classify the pet images by pets according to the result of mapping.

When a specific pet guardian requests an image of guardian's own pet obtained in the pet care facility through a user terminal, the system may deliver the image of the pet that is stored after being filtered to the user terminal.

For example, as shown in FIG. 6, when the pet guardian writes a post through the user terminal and clicks a photo icon outputted on the screen, only the photo of the guardian's pet among the pet photos obtained at the pet care facility may be automatically loaded (delivered) and may be outputted on the screen.

The technical concept of the disclosure may be applied to a computer-readable recording medium which records a computer program for performing the functions of the apparatus and the method according to the present embodiments. In addition, the technical idea according to various embodiments of the disclosure may be implemented in the form of a computer readable code recorded on the computer-readable recording medium. The computer-readable recording medium may be any data storage device that can be read by a computer and can store data. For example, the computer-readable recording medium may be a read only memory (ROM), a random access memory (RAM), a CD-ROM, a magnetic tape, a floppy disk, an optical disk, a hard disk drive, or the like. A computer readable code or program that is stored in the computer readable recording medium may be transmitted via a network connected between computers.

In addition, while preferred embodiments of the present disclosure have been illustrated and described, the present disclosure is not limited to the above-described specific embodiments. Various changes can be made by a person skilled in the at without departing from the scope of the present disclosure claimed in claims, and also, changed embodiments should not be understood as being separate from the technical idea or prospect of the present disclosure.

1. A method for classifying pet photos based on image tagging, the method comprising:
a step of registering, by a system, information on a pet and information on a pet guardian which are received from a user terminal;
a step of making a reservation, by the system in conjunction with the user terminal, for the use of a pet care facility, based on the information on the pet and the information on the pet guardian; and
a step of determining, by the system, whether the pet has visited the pet care facility, based on a photo of the pet taken on the site of the pet care facility and reservation information registered while making the reservation.

2. The method of claim 1, wherein the step of determining whether the pet has visited the pet care facility comprises, when the pet photo taken on the site of the pet care facility is uploaded, determining whether the pet has visited the pet care facility, based on the reservation information registered while making the reservation and the uploaded pet photo.

3. The method of claim 2, wherein the step of making the reservation comprises making the reservation only when the pet guardian logged into a specific user terminal registers (purchases) a voucher of the pet care facility, and
wherein the step of determining whether the pet has visited the pet care facility comprises, when the visit of the pet to the pet care facility is recognized based on the pet photo taken on the site of the pet care facility, automatically deducting the number of times that the pet guardian uses the voucher registered (purchased) at the user terminal.

4. The method of claim 3, wherein the system is configured to, when the visit of the pet to the pet care facility is recognized through the pet photo taken on the site of the pet care facility, cause the name of the pet selected from a visit list or extracted from the reservation information to be stored as tagged onto the photo.

5. The method of claim 2, wherein the system is configured to extract an image of a specific pet by performing object detection for detecting the specific pet from a photo or a captured image including a plurality of pets by using a Few Shot Learning algorithm and Siamese Neural Networks.

6. The method of claim 5, wherein the system is configured to, when the Few Shot Learning algorithm and the Siamese Neural Networks are used, apply pet photos included in the information of the pets registered or pet photos taken on the site of the pet care facility as a Support Set, and to apply the photo or captured image including the plurality of pets as a Query Set.

7. The method of claim 6, further comprising, when the photo or captured image including the plurality of pets in the pet care facility is obtained, individually extracting, by the system, respective images of pets and mapping the images onto a most similar group within the Support Set, and classifying the images of the pets by pets according to the result of mapping.

8. The method of claim 7, wherein the classified pet images are filtered based on a pet care facility using time of each pet, and are stored.

9. The method of claim 8, further comprising, when a specific pet guardian requests an image of a pet obtained in the pet care facility through a user terminal, delivering, by the system, the image that is filtered and stored to the user terminal.

10. A system for classifying pet photos based on image tagging, the system comprising:
a processor configured to register information on a pet and information on a pet guardian which are received from a user terminal, to make a reservation for the use of a pet care facility, based on the information on the pet and the information on the pet guardian, in conjunction with the user terminal, and to determine whether the pet has visited the pet care facility, based on a photo of the pet taken on the site of the pet care facility and reservation information registered while making the reservation; and
a storage unit configured to store the information on the pet and the information on the pet guardian which are registered, and the reservation information registered while making the reservation.
